(19) United States
(12) Patent Application Publication
(10) Pub. No.: US 2017/0251668 A1
(43) Pub. Date: Sep. 7, 2017

(54) Composition and Method for Fighting Phytopathogenic Fungi

(71) Applicant: Hochschule Anhalt, Koethen (DE)

(72) Inventors: Helmut BALTRUSCHAT, Ziemendorf (DE); Kathrin KABRODT, Bernburg (DE); Ingo SCHELLENBERG, Dessau-Rosslau (DE)

(21) Appl. No.: 15/506,159

(22) PCT Filed: Sep. 3, 2015
(86) PCT No.: PCT/DE2015/000443

§ 371 Date: Feb. 23, 2017

(30) Foreign Application Priority Data
Sep. 4, 2014 (DE) 10 2014 013 302.8

(51) Int. Cl. A01N 43/16

(52) U.S. Cl. CPC A01N 43/16

(57) ABSTRACT

A composition of active ingredients for fighting plant diseases, composed of at least two different active ingredients, selected from the group of stilbenes and/or derivatives thereof on the one hand and of the group of galloylated flavan-3-ols and/or derivatives thereof, and/or of the group of proanthocyanidins and/or derivatives thereof on the other hand. As an alternative, the at least two different active ingredients can be selected from the group of galloylated flavan-3-ols and/or derivatives thereof and/or from the group of proanthocyanidins and/or derivatives thereof. The novel mixtures have a higher effect than the individual components, there is a synergistic effect. The invention further relates to a method for fighting fungal plant diseases using the aforementioned active ingredients.

The invention relates to an active ingredient composition for fighting plant diseases. This active ingredient composition is a fungicidal mixture of compounds in a synergistically effective amount. The invention further relates to an active ingredient formulation and to the use of the active ingredient composition or the active ingredient formulation for fighting fungal plant diseases. In addition, the invention relates to a method for fighting fungal plant diseases.

Compounds from the group of flavan-3-ols and stilbenes and their efficacy against harmful fungi are fundamentally known from the literature, for example from Caruso et al. (2011) “Antifungal Activity of Resveratrol against Botrytis cinerea Is Improved Using 2-Furyl Derivatives” PLoS ONE 6 (10):e25421.doi:10.1371/journal.pone.0025421; Albert et al. (2011) “Synthesis and antimicrobial activity of (E) stilbene derivatives”, Bioorganic & Medicinal Chemistry, 19 (2011) 5155-5166; Seppänen et al. (2004) “Antifungal activity of stilbenes in in vitro bioassays and transgenic Populus expressing a gene encoding pinosylvin synthase”, Plant Cell Reports 22:584-593; and M. Wilmot: “Inhibition of Phytopathogenic Fungi on Selected Vegetable Crops by Catechins, Caffeine, Theanine and Extracts of Camellia sinensis (L.) O. Kuntze”, Master Thesis, Faculty of Natural and Agricultural Sciences, University of Pretoria, September 2006 (Sep. 1, 2006), pages 1 to 132.

The present invention is based on the object to achieve an improved efficacy against harmful fungi while applying a smaller quantity of active ingredients.

The object is attained with an active ingredient composition having the features according to independent claim 1 or claim 2. Further embodiments are recited in the dependent claims.

With the aim of reducing the application rates and improving the activity spectrum of known compounds, for example galloylated flavan-3-ols and stilbenes, the present invention is based on synergistic mixtures which have an improved efficacy against harmful fungi while the total amount of active ingredients applied is reduced.

In addition to the mixtures defined at the outset, it has also been found that harmful fungi can be treated more effectively when the compounds are applied simultaneously, either in combination or separately, or when the compounds are applied consecutively, than when the individual compounds are applied alone.

The mixtures of galloylated flavan-3-ols and stilbenes or their derivatives, when applied simultaneously, either together or separately, are distinguished by excellent efficacy against a broad spectrum of plant pathogenic fungi, in particular from the class of the ascomycetes, basidiomycetes, phycomycetes and deuteromycetes.

An active ingredient composition according to the invention for fighting plant diseases is composed of at least two different active ingredients selected, on the one hand, from the group of stilbenes and/or their derivatives, and on the one hand from the group of galloylated flavan-3-ols and/or their derivatives and/or from the group of proanthocyanidins and/or their derivatives.

An alternative active ingredient composition according to the invention for fighting plant diseases is composed of at least two different active ingredients selected from the group of the galloylated flavan-3-ols and/or their derivatives and/or from the group of proanthocyanidins and/or their derivatives.

In the context of the present invention, the term “derivatives” refers to compounds which are formed by modification reactions such as esterifications, alkylations, aldol reactions, cycloadditions, decarboxylations, oxidations/reductions, hydroxylations, cyclizations, methylations, acylations, galloylations, glycolysis reactions, polymerizations of the abovementioned compounds.

The at least two different active ingredients are advantageously mixed together in a ratio from 1:1 to 1:8, preferably in a range from 1:1 to 1:4, particularly preferably in a range from 1:1 to 1:2, including the limiting ratios. The order of the listed compounds is not defined here, meaning that the range for the ratio could accordingly also be described by 8:1, 4:1 or 2:1 to 1:1, respectively, when the compound with the larger proportion is mentioned first. Within the context of the brief description of the present invention and the claims, the first number always refers to the active ingredient with the smaller proportion and the latter number to the active ingredient with the larger proportion in the active ingredient composition when indicating the preferred ranges for the ratios between the active ingredients, irrespective of which of the active ingredients each forms the smaller or the larger proportion.

In one embodiment of the invention, the active ingredient composition is composed of at least two different flavan-3-ols or their derivatives. A combination of the two different flavan-3-ols epigallocatechin gallate and gallocatechin has proven to be particularly advantageous.

In another embodiment of the invention, the active ingredient composition is composed of, on the one hand, at least one flavan-3-ol or a derivative of a flavan-3-ol and, on the other hand, at least one stilbene or a derivative of a stilbene. Such a mixture may consist, for example, of epigallocatechingallate and resveratrol (trans-3,5,4′-trihydroxystilbene),

Another particularly advantageous active ingredient composition is composed of at least one proanthocyanidin or a derivative of a proanthocyanidine and at least one stilbene or a derivative of a stilbene. An example of such a composition is a mixture of procyanidine B2 and rhaponticin.

Another advantageous active ingredient composition is composed of at least two different stilbenes or their derivatives.

When using the active ingredient combination according to the invention, the application rates can be varied over a relatively wide range depending on the type of application. In the treatment of plant parts, the application rates of active ingredient combinations are generally between 0.1 and 10,000 g/ha, preferably between 10 and 1000 g/ha (g/ha=grams per hectare).

The active ingredient combination contained in the composition can be applied as such, in the form of its formulations or the applications prepared therefrom, such as ready-to-use solutions, emulsifiable concentrates, emulsions, suspensions, spray powders, soluble powders and granules. Another aspect of the present invention therefore relates to an active ingredient formulation consisting of a ready-to-use solution, an emulsifiable concentrate, an emulsion, a suspension, a spray powder, a soluble powder and/or a granulate of the abovementioned active ingredient composition and optionally additional additives, in particular adjuvants. The concentration of the active ingredients in the active ingredient formulation is generally between 4 and 2000 ppm, preferably between 8 and 500 ppm.

Preferably water, optionally with admixtures of additional solvents, for example ethanol, is used as a solvent.

The abovementioned active ingredient composition or the abovementioned active ingredient formulation can be used for fighting fungal plant diseases, with the phytopathogenic fungi to be attacked including one or more phytopathogenic fungi.

Another aspect of the invention relates to a method for fighting fungal plant diseases wherein at least two different active ingredients selected, on the one hand, from the group of stilbenes and/or their derivatives and/or on the other hand, from the group of the galloylated flavan-3-ols and/or their derivatives and/or from the group of the proanthocyanidins and/or their derivatives, are applied on a plant to be treated either simultaneously, i.e. together or separately, or consecutively as such or in their formulations. Alternatively, the at least two different active ingredients are selected from the group of the galloylated flavan-3-ols and/or their derivatives and/or from the group of proanthocyanidins and/or their derivatives. The sequential order in a separate application has generally no effect on the success of the control. If pathogenic harmful fungi in plants are to be attacked, for example, a first compound I and a second compound II are applied separately or jointly, or the soil is treated before or after seeding of the plants or before or after the plants emerge. The fungicidal synergistic mixtures according to the invention, for example from compound I and compound II, may advantageously be processed in the form of directly sprayable solutions, powders and suspensions or in the form of highly concentrated aqueous, oily or other suspensions, dispersions, emulsions, oil dispersions, pastes, dusts, granules and can be applied by spraying, misting, dusting, scattering or pouring. The form of application depends on the intended use, but should in any event ensure the finest and most uniform distribution of the mixture according to the invention.

The formulations are prepared in a conventional manner, for example by adding solvents and/or carrier substances. Typically, inert additives such as emulsifiers or dispersants are admixed to the formulations.

Suitable surface-active ingredients are alkaline metal salts, alkaline earth metal salts, ammonium salts of aromatic sulfonic acids, for example lignin acid, phenolic acid, naphthalene acid and dibutylnaphthalenesulfonic acid, as well as fatty acids, alkyl- and alkylarylsulfonates, alkyl, lauryl ether and fatty alcohol sulfates, and salts of sulfated hexadecanol, heptadecanol and octadecanol, or of fatty alcohol glycolethers, condensation products of sulfonated naphthalenes or of naphthalenesulfonic acids with phenol and formaldehyde, polyoxyethylene octyphenol ethers, ethoxylated isooctylphenol, octylphenol or nonylphenol, alkylphenol- or tributylphenylpolyglycol ethers, alkylaryl polyether alcohols, isotridecyl alcohol, fatty alcohol ethylene oxide condensates, ethoxylated castor oil, polyoxyethylene alkyl ethers or polyoxypropylene, lauryl alcohol polyglycol ether acetate, sorbitan esters, lignin sulfite waste solutions or methylcellulose.

Powders, scattering agents and dusting agents can be prepared by mixing or jointly grinding the compounds I or II or a mixture of the compounds I and II with a solid carrier. Granules, for example coating, impregnating or homogeneous granules, are usually prepared by binding the active ingredient or the active ingredients to a solid carrier.

Examples of fillers or solid carriers, respectively, are for example mineral deposits such as silica gel, silica, silica gel, silicates, talc, kaolin, limestone, lime, chalk, bolus, loess, clay, dolomite, diatomaceous earth, calcium and magnesium sulfate, magnesium oxide, ground plastic materials, as well as fertilizers such as ammonium sulfate, ammonium phosphate, ammonium nitrate, urea and plant products such as cereal flour, tree bark powder, wood powder and nutshell powder, cellulose powder or other solid carriers.

The formulations generally contain one of the compounds I or II or of the mixture of the compounds I and II in a concentration from 0.1 to 95% by weight, preferably from 0.5 to 90% by weight. The active ingredients are present in a purity from 90% to 100%, preferably 95% to 100%, determined by an NMR or HPLC spectrum.

The application can be carried out before and/or after the attack by the harmful fungi.

The active ingredients as such or their formulations can also be applied as a mixture, i.e. simultaneously, before or afterwards in conjunction with further fungicides, bactericides, acaricides, nematicides, insecticides and/or additional active ingredients, such as herbicides, and/or with fertilizers and/or growth regulators. When using the active ingredient combination according to the invention, the application rates may be varied over a relatively wide range depending on the type of application. When treating plant parts, the application rates of the active ingredient combination are generally between 4 and 2000 ppm, preferably between 8 and 500 ppm.

The active ingredient compositions and formulations according to the invention are particularly important for fighting a variety of fungi on various crops such as barley, wheat, oats, rye, corn, rice, cotton, vegetable plants such as cucumbers, beans, tomatoes, potatoes and pumpkin plants, as well as bananas, coffee, fruit plants soy, vines, ornamental plants or sugar cane.

The active ingredient compositions and formulations according to the invention are particularly suitable for fighting the following phytopathogenic fungi or pathogens: Erysiphe graminis (powdery mildew) on cereal, Erysiphe cichoracearum and Sphaerotheca fuliginea on cucurbits, Podosphaera leucotricha on apples, Uncinula necator on vines, Puccinia species on cereal and soy, Rhizoctonia species on cotton, rice and lawns, Ustilago species on grain and sugar cane, Venturia inaequalis (scab) on apples, Helminthosporium species on cereal, Septoria nodorum on wheat, Botrytis cinerea (gray mold) on strawberries, vegetables, ornamentals and vines, Cercospora arachidicola on peanuts, Pseudocercosporella herpotrichoides on wheat and barley, Pyricularia oryzae on rice, Phytophthora infestans on potatoes and tomatoes, Phytophthora capsici on tomatoes or paprika, Plasmopara viticola on vines, Pseudocercosporella typologies in hops and cucumbers, Alternaria typologies on vegetables and fruit, Mycosphaerella species in bananas, Sclerotinia sclerotiorum on oilseed rape and vegetables, and Fusarium—and Verticillium species on various crops.

Further details, features and advantages of embodiments of the invention can be inferred from the following description of exemplary embodiments with reference to the accompanying drawings, which show in:

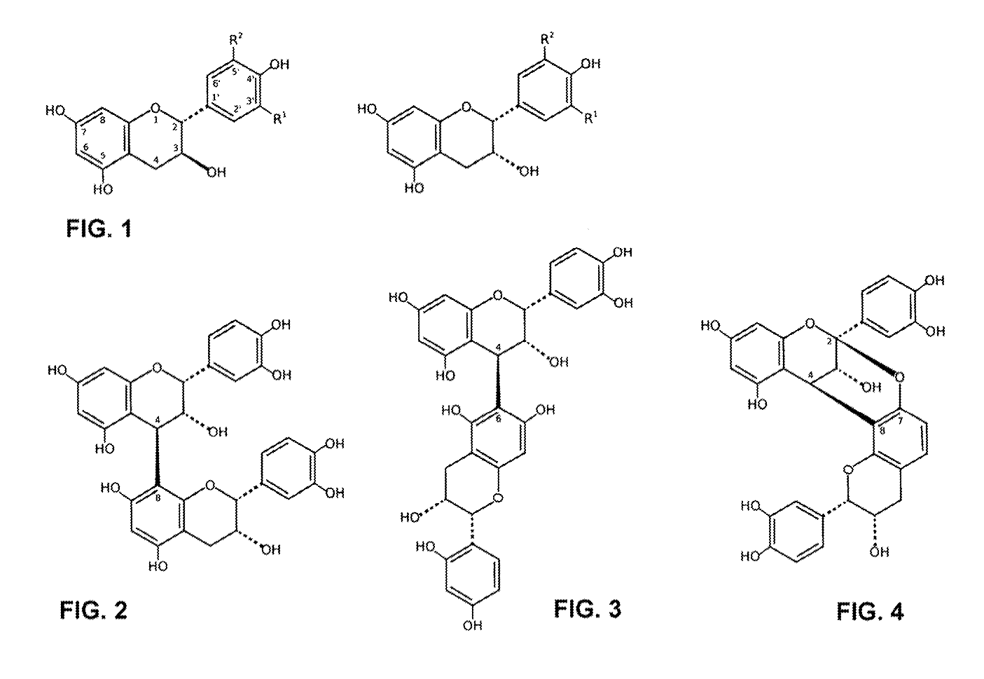

FIG. 1 the known general structural formula of flavan-3-ols,

FIG. 2 the known structural formula of procyanidin B2,

FIG. 3 the known structural formula of procyanidin B5,

FIG. 4 the known structural formula of procyanidin A1,

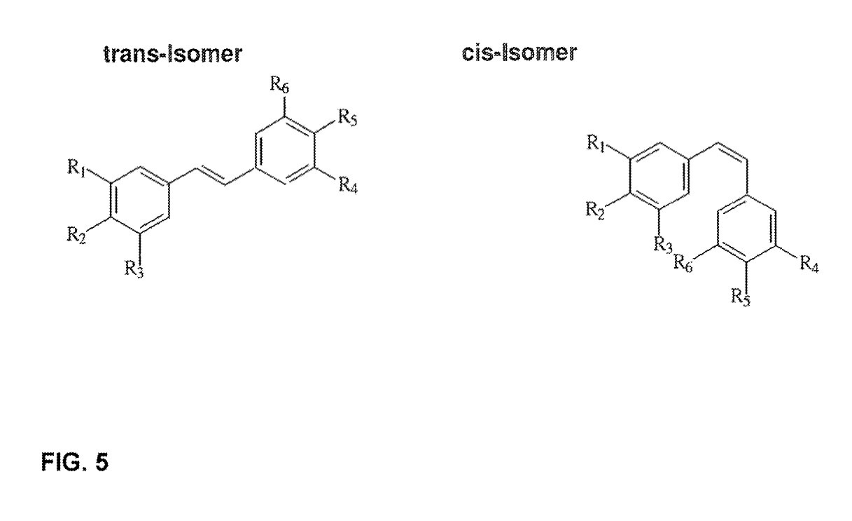

FIG. 5 the known basic structural formula of stilbenes as trans-isomer and as cis-isomer,

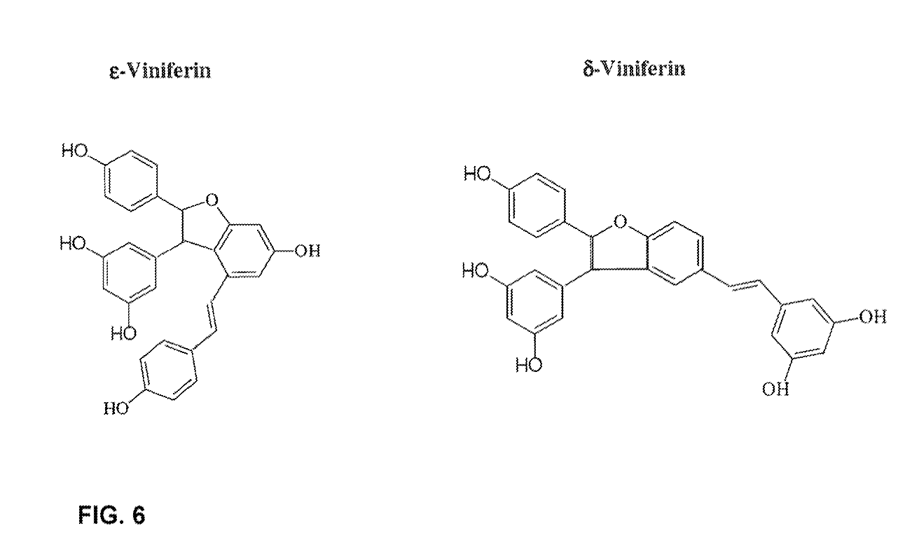

FIG. 6 examples of known stilbene derivatives,

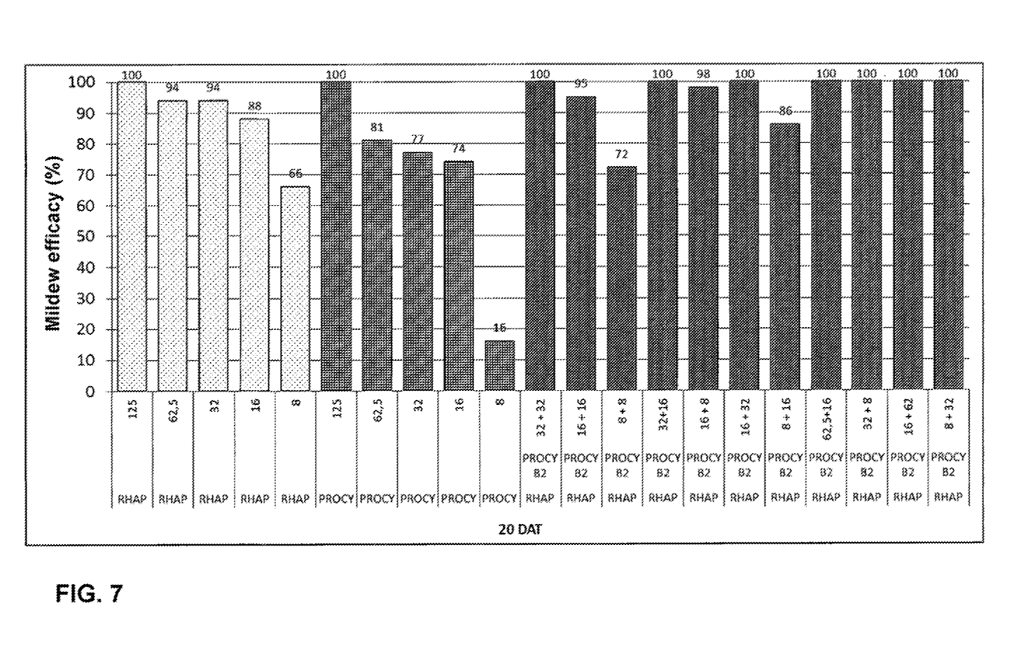

FIG. 7 a graphical representation of fungicidal efficacy of a mixture of rhaponticin and procyanidin B2,

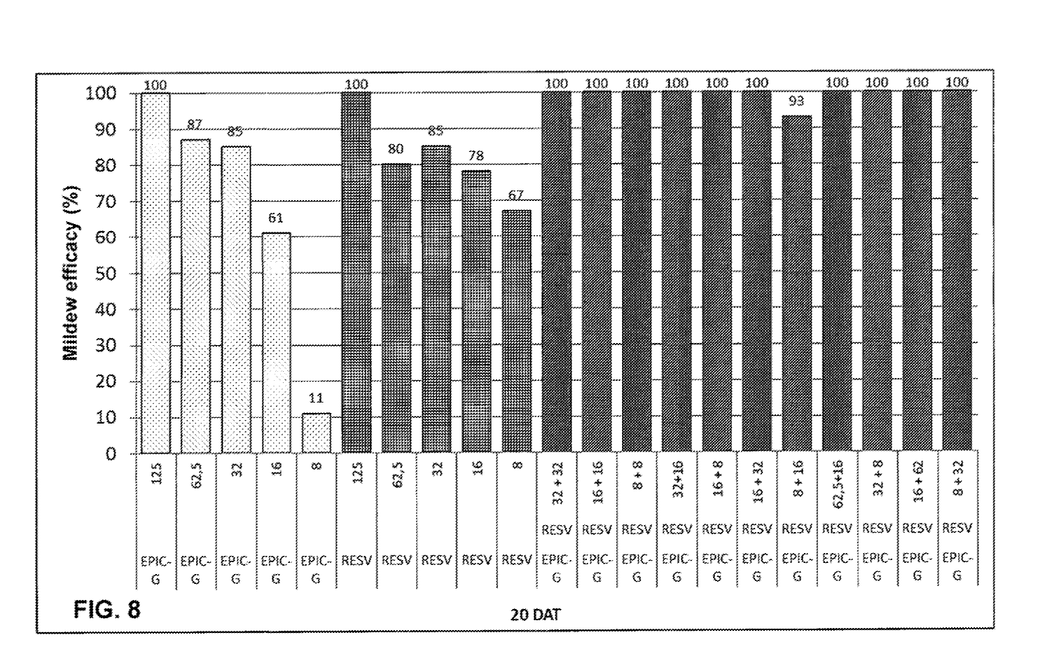

FIG. 8 a graphical representation of the fungicidal efficacy of a mixture of epigallocatechingallate and resveratrol,

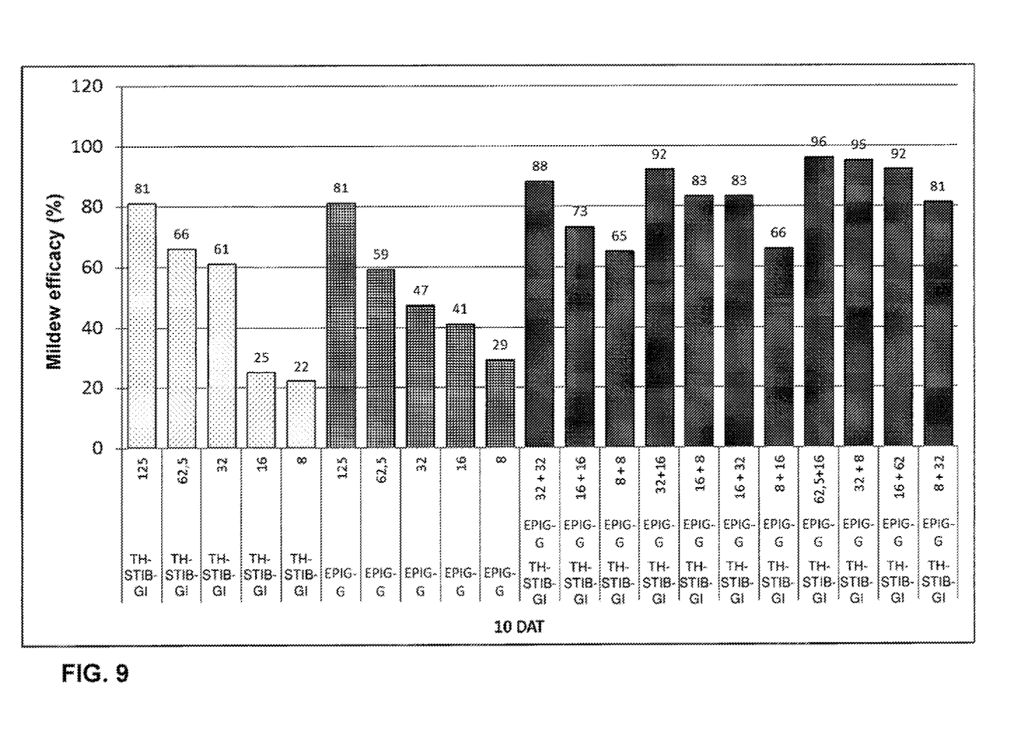

FIG. 9 a graphical representation of the fungicidal efficacy of a mixture of epigallocatechingallate and trihydroxy-stilbenglucoside, and

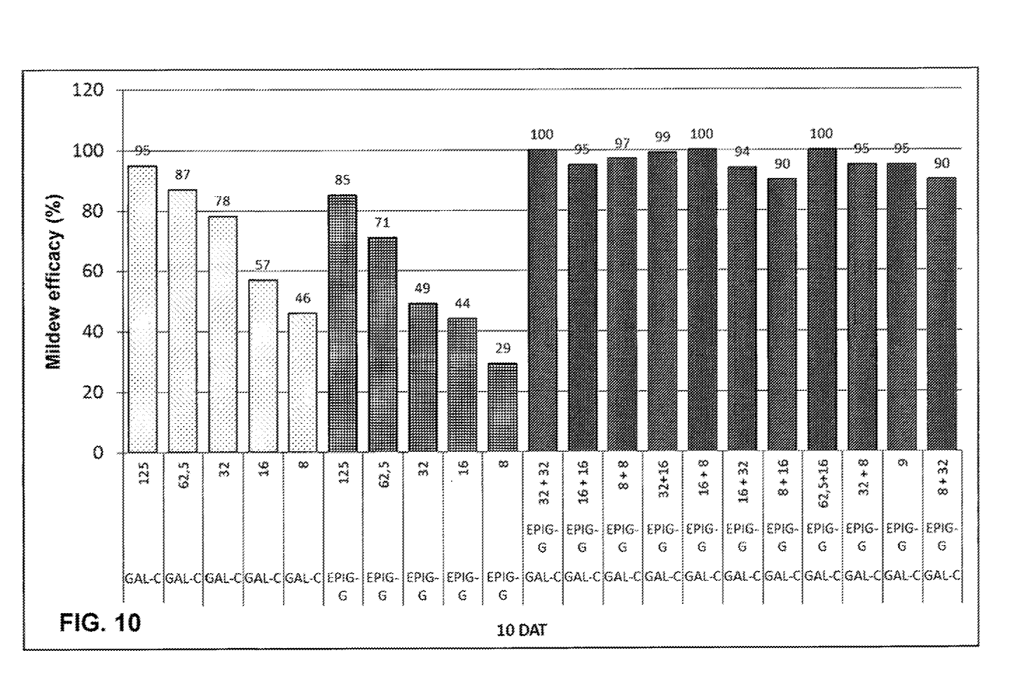

FIG. 10 a graphical representation of the fungicidal efficacy of a mixture of gallocatechin and epigallocatechin gallate.

Flavan-3-ols are compounds with the known basic structure shown in FIG. 1. Examples of important representatives of these compounds are listed below with the corresponding association R¹ and R² of the structural formula:

R¹═H; R²═H: afzelechin

R¹═H; R²═H: epiafzelechin

R¹═OH; R²═H: catechin

R¹═OH; R²═H: epicatechin

R¹═OH; R²═OH: gallocatechin

R¹═OH; R²═OH: epigallocatechin

Proanthocyanidins are compounds composed of linked flavan-3-ol moieties. Various types of links are shown below. A representative of the proanthocyanidins epicatechin-(4β→8)-epicatechin referred to as procyanidin B2, shown in FIG. 2. Other proanthocyanidins are the compound epicatechin (4β→6)-epicatechin referred to as procyanidin B5 having the structural formula shown in FIG. 3, and epicatechin (4β→8,2β→7) catechin referred to as procyanidin A1 with the structural formula shown in FIG. 4.

FIG. 5 shows the basic structural formula of stilbenes as trans-isomer and a cis-isomer. Table 1 lists the corresponding radicals R1 to R6 for different stilbenes.

TABLE 1

| Stilbene | R1 | R2 | R 3 | R4 | R5 | R6 |
|---|---|---|---|---|---|---|
| Resveratrol | OH | H | OH | H | OH | H |
| Piceid = 3,5,4′-trihydroxy- | glucose | H | OH | H | OH | H |
| stilbene-3-O-β-D-glucoside | | | | | | |
| Astringine (3′-OH-piceide) | glucose | H | OH | OH | OH | H |
| Piceatannol = 3,3′,4′,5- | OH | OH | H | OH | H | OH |
| tetrahydroxystilbene | | | | | | |
| Pterostilbene | OCH₃ | H | OCH₃ | H | OH | H |
| Resveratroloside | OH | H | OH | H | glucose | H |

Table 2 lists the radicals R1, R2 and R3 for various stilbene derivatives.

TABLE 2

| | R1 | R2 | R3 |
|---|---|---|---|
| Name of the compound | at C-3 | at C-4′ | at C-3′ |
| 3,5,4′-trihydroxy stilbene-4′- | H | glucose | H |
| O-β-D-glucoside | | | |
| 3,5,4′-trihydroxy stilbene-4′- | H | 6-O- | H |
| O-β-D-(6″-O-galloyl) glucoside | | galloylglucose | |
| Rhapontigenin-3′-O-β-D- | H | CH₃ | O- |
| glucopyranoside | | | glucose |
| Rhaponticin-6″-O-gallate | 6-O- | CH₃ | OH |
| | galloyl- | | |
| | glucose | | |
| Rhaponticin-2″-O-gallate | 2-O- | CH₃ | OH |
| | galloyl- | | |
| | glucose | | |
| Rhaponticin-2″-O-coumarate | 2-O- | CH₃ | OH |
| | coumaroyl | | |
| | glucose | | |
| Piceatannol-3-O-β-D- | glucose | H | OH |
| glucopyranoside | | | |
| Piceatannol-3′-O-.β.-D- | H | H | O- |
| glucopyranoside | | | glucose |
| Piceatannol-3′-O-.β.-D- | H | H | O-xylose |
| xylopyranoside | | | |
| Piceatannol-3′-O-.β.-D-(6″-O- | H | H | O-(6- |
| galloyl) glucopyranoside | | | galloyl)- |
| | | | glucose |
| Deoxyrhaponticin-6″-O-gallate | 6-O- | CH₃ | H |
| | galloyl- | | |
| | glucose | | |
| 3,4′,5-trihydroxy-stilbene-4′- | H | 6- | H |
| O-β-D-(6″-O-galloyl) glucoside | | galloylglucose | |

Table 3 shows the corresponding radicals R1, R2 and R3 for the stilbene rhaponticin and for rhaponticin derivatives.

TABLE 3

| | R1 | R2 |
|---|---|---|
| Name of the compound | at C-3 | at C-4′ |
| Rhaponticin | glucose | CH₃ |
| Rhapontigenin | H | CH₃ |
| Deoxyrhaponticin | glucose | CH₃ |
| Deoxyrhapontigenin | H | CH₃ |
| Dioxyrhaponticin | glucose | OH |

FIG. 6 shows the structural formulas of the resveratrol dimers e-Viniferin and d-Viniferin as examples of stilbene derivatives.

Material and Methods

Barley plants (3 plants/container) were cultivated for three weeks in Frustrorf soil. The inoculation of the leaves with mildew took place 2 hours after application of the test preparations (protective application). Fresh conidia of Blumeria graminis f. sp. hordei were used for the inoculation, species A6, and carried onto the leaves in the mildew tower by way of wind distribution. For a leaf segment test, 10 cm long leaf segments, starting from the stalk base, were cut off and 15 leaves of the youngest as well as the second youngest leaf were laid out on benzimidazole agar. The benzimidazole agar consists of 0.5% agar and an admixture of 40 ppm benzimidazole in one liter of water.

The concentration of the standard substances for the leaf application was adjusted to 125, 62.5, 32, 16 and 8 ppm. An adjuvant was added to the standard substances with BT S240 (50 ml/ha) in order to ensure a uniform distribution of the application solution on the leaf. The mildew effect was evaluated by counting the mildew blisters per leaf on a 7 cm long leaf.

The beneficial fungicidal action of the active ingredient combination according to the invention is evident from the following examples. While the individual active ingredients in the fungicidal action show weaknesses, the combinations of two active ingredients exhibit an efficacy that exceed the efficacy attained by simply adding the individual efficacy.

A synergistic effect is always present in fungicides/antifungal compounds when the fungicidal action of the active ingredient combination is greater than the sum of the individual efficacies.

The expected efficacy for a given combination of two or three active ingredients can be calculated according to S. R. Colby (“Calculating Synergistic and Antagonistic Responses of Herbicide Combinations”, Weeds 1967, 15, 20-22) as follows:

$${E}_{1} = X + Y - \frac{X - Y}{100} ,$$

or when using three active ingredients

$${E}_{2} = X + Y + Z - \frac{X - Y - Z}{100} ,$$

Note that it wrongly says E1 in the PCT and DE text.

wherein

X represents the efficacy when using the active compound A in an application rate of mg/ha,

Y represents the efficacy when using the active compound B in an application rate of mg/ha,

Z represents the efficacy when using the active compound C in an application rate of mg/ha,

E1 represents the efficacy when using the active ingredients A and B in application rates of m and n g/ha, and

E2 represents the efficacy when using the active ingredients A and B and C in application rates of m, n and r g/ha.

The results of the efficacy against barley powdery mildew (Blumeria graminis f. sp. Hordei) show a synergistic effect at certain mixing ratios, as seen in the following tables. In Table 1, the efficacies calculated for mixtures of the stilbene glucoside rhaponticin (RHAP) as a stilbene derivative and procyanidin B2 (PROCY) based on the known efficacy of the individual substances are compared with the observed efficacies. The concentration-dependent efficacies for the individual substances and the mixtures are shown graphically in FIG. 7. In this example and in the following examples, the reference quantity 100 for the efficacy is the efficacy achieved with a concentration of 125 ppm of the respective pure substance. Table 4 and FIG. 7 demonstrate that a synergistic effect, as described above, could be observed at all the used mixture ratios. This means that when using the mixtures, the calculated efficacies of the individual substances are exceeded.

TABLE 4

| | | Observed | Calculated |
|---|---|---|---|
| Example | Mixture according to the invention | efficacy | efficacy |
| 1 | Control (untreated) | (100% | 0 |
| | | infection) | |
| 2 | RHAP + PROCY (16 + 16 ppm) | 100 | 96 |
| 3 | RHAP + PROCY (8 + 8 ppm) | 72 | 45 |
| 4 | RHAP + PROCY (32 + 16 ppm) | 100 | 98 |
| 5 | RHAP + PROCY (16 + 8 ppm) | 98 | 90 |
| 6 | RHAP + PROCY (16 + 32 ppm) | 100 | 97 |
| 7 | RHAP + PROCY (8 + 16 ppm) | 86 | 91 |
| 8 | RHAP + PROCY (62.5 + 16 ppm) | 100 | 98 |
| 9 | RHAP + PROCY (16 + 62.5 ppm) | 100 | 97 |
| 10 | RHAP + PROCY (8 + 32 ppm) | 100 | 92 |

In Table 5, the efficacies calculated for mixtures of epigallocatechin gallate (EPIC-G) as flavan-3-ol and resveratrol (RESV) as stilbene with the systematic designation trans-3,5,4′-trihydroxystilbene are compared with the observed efficacies. The concentration-dependent efficacies for the used individual substances and for the mixtures are shown graphically in FIG. 8. Table 5 and FIG. 8 show that a synergistic effect, as described above, could be observed at all the used mixture ratios. This means that the calculated efficacies are always exceeded when the mixtures are used.

TABLE 5

| | | Observed | Calculated |
|---|---|---|---|
| Example | Mixture according to the invention | efficacy | efficacy |
| 1 | Control (untreated) | (100% | 0 |
| | | infection) | |
| 2 | EPIC-G + RESV (16 + 16 ppm) | 100 | 91 |
| 3 | EPIC-G + RESV (8 + 8 ppm) | 100 | 71 |
| 4 | EPIC-G + RESV (32 + 16 ppm) | 100 | 97 |
| 5 | EPIC-G + RESV (16 + 8 ppm) | 100 | 87 |
| 6 | EPIC-G + RESV (16 + 32 ppm) | 100 | 94 |
| 7 | EPIC-G + RESV (8 + 16 ppm) | 93 | 80 |
| 8 | EPIC-G + RESV (62.5 + 16 ppm) | 100 | 98 |
| 9 | EPIC-G + RESV (16 + 62.5 ppm) | 100 | 92 |
| 10 | EPIC-G + RESV (8 + 32 ppm) | 100 | 87 |

In Table 6, the efficacies calculated for mixtures of epigallocatechin gallate (EPIC-G) as flavan-3-ol and trihydroxystilbenglucoside (TH-STIB-GI) as stilbene are compared with the observed efficacies. The concentration-dependent efficacies for the used individual substances and for the mixtures are shown graphically in FIG. 9. Table 6 and FIG. 9 show that that a synergistic effect, as described above, could be observed at all the used mixture ratios.

TABLE 6

| | | Observed | Calculated |
|---|---|---|---|
| Example | Mixture according to the invention | efficacy | efficacy |
| 1 | Control (untreated) | (100% | 0 |
| | | infection) | |
| 2 | TH-STIB-GI + EPIC-G (16 + 16 ppm) | 73 | 56 |
| 3 | TH-STIB-GI + EPIC-G (8 + 8 ppm) | 65 | 45 |
| 4 | TH-STIB-GI + EPIC-G (32 + 16 ppm) | 92 | 77 |
| 5 | TH-STIB-GI + EPIC-G (16 + 8 ppm) | 83 | 67 |
| 6 | TH-STIB-GI + EPIC-G (16 + 32 ppm) | 83 | 60 |
| 7 | TH-STIB-GI + EPIC-G (8 + 16 ppm) | 66 | 54 |
| 8 | TH-STIB-GI + EPIC-G (62.5 + 16 ppm) | 96 | 80 |
| 9 | TH-STIB-GI + EPIC-G (16 + 62.5 ppm) | 92 | 69 |
| 10 | TH-STIB-GI + EPIC-G (8 + 32 ppm) | 81 | 74 |

In Table 7, the efficacies calculated for mixtures of gallocatechin (GAL-C) as flavan-3-ol and epigallocatechin gallate (EPIC-G) as additional flavan-3-ol are compared with the observed efficacies. The concentration-dependent efficacies for the used individual substances and for the mixtures are shown graphically in FIG. 10. Table 7 and FIG. 10 show that a synergistic effect, as described above, could be observed at ail the used mixture ratios.

TABLE 7

| | | Observed | Calculated |
|---|---|---|---|
| Example | Mixture according to the invention | efficacy | efficacy |
| 1 | Control (untreated) | (100% | 0 |
| | | infection) | |
| 2 | GAL-C + EPIC-G (16 + 16 ppm) | 95 | 76 |
| 3 | GAL-C + EPIC-G (8 + 8 ppm) | 97 | 62 |
| 4 | GAL-C + EPIC-G (32 + 16 ppm) | 99 | 88 |
| 5 | GAL-C + EPIC-G (16 + 8 ppm) | 100 | 69 |
| 6 | GAL-C + EPIC-G + (16 + 32 ppm) | 94 | 78 |
| 7 | GAL-C + EPIC-G + (8 + 16 ppm) | 90 | 70 |
| 8 | GAL-C + EPIC-G + (62.5 + 16 ppm) | 100 | 93 |
| 9 | GAL-C + EPIC-G + (16 + 62.5 ppm) | 95 | 88 |
| 10 | GAL-C + EPIC-G + (8 + 32 ppm) | 90 | 72 |

The excellent fungicidal efficacy of the active ingredient combination of the invention against oat crown rust (Puccinia coronata) is evident from the following examples. While the individual active ingredients have weaknesses in their fungicidal efficacy, the respective combinations show an efficacy that exceeds that of a simple addition of the individual efficacies. The results of the efficacy against oat crown rust (Puccinia coronata) show a synergistic effect at certain mixing ratios, as shown in the following tables.

Rhaponticin (=RHAP) and procyanidin B2 (=PROCY) and epigallocatechin gallate (=EPIC-G) and resveratrol (=RESV) were also tested against oat crown rust (Puccinia coronata) in different concentrations, see Table 8 and Table 9. Oats were cultivated for three weeks in Frustrorfer soil. An adjuvant of BT S240 was added to the standard substances (50 ml/ha) to ensure a uniform distribution of the application solution on the leaf. The leaves were inoculated with oat crown rust 8 hours after application of the standard substances (protective application). For the application, uredo spores of oat crown rust (Puccinia coronata) were taken up by a medium which consisted of a mixture of methyl nonafluoroisobutyl ether and methyl nonafluorobutyl ether. With this mixture, the medium evaporates very quickly after application to the leaves, and the rust spores previously distributed with the medium remain on the leaf surface. After this medium was applied, the plants were incubated in the dark for 24 h and then laid out in the leaf segment test. For a leaf segment test, 10 cm long leaf segments, starting from the stalk base, were cut off and 15 leaves of the youngest as well as the second youngest leaf were laid out on benzimidazol agar (0.5% agar, admixture of 40 ppm benzimidazole after autoclaving). The efficacy against oat crown rust was evaluated by counting the rust blisters per leaf on a 7 cm long leaf. The classification took place after 20 DAT (days after treatment). The synergistic effect was again calculated according to the Colby formula.

Oat crown rust (Puccinia coronata) was chosen as a model for examining the synergistic effect against rust diseases to show that the compounds of the invention are capable of synergistically attacking also rust diseases in addition to mildew diseases. Major rust diseases include, among others, major rust diseases in cereal such as yellow rust (Puccinia striiformis), brown rust (Puccinia recondita), leaf rust (Puccinia hordei) or black rust (Puccinia graminis). Important other rust diseases are found in soy (Phakopsora pachyrhizi) or in roses, pears, turf grasses.

TABLE 8

| | Mixture according | Observed | Calculated |
|---|---|---|---|
| Example | to the invention | efficacy | efficacy |
| 1 | Control (untreated) | (100% | 0 |
| | | infection) | |
| 2 | RHAP + PROCY | 86 | 74 |
| | (62.5 + 62.5 ppm) | | |
| 3 | RHAP + PROCY | 75 | 62 |
| | (32 + 32 ppm) | | |
| 4 | RHAP + PROCY | 64 | 45 |
| | (16 + 16 ppm) | | |
| 5 | RHAP + PROCY | 84 | 70 |
| | (62.5 + 32 ppm) | | |
| 6 | RHAP + PROCY | 73 | 52 |
| | (32 + 16 ppm) | | |
| 7 | RHAP + PROCY | 81 | 68 |
| | (32 + 62.5 ppm) | | |
| 8 | RHAP + PROCY | 73 | 58 |
| | (16 + 32 ppm) | | |
| 9 | RHAP + PROCY | 90 | 77 |
| | (125 + 32 ppm) | | |
| 10 | RHAP + PROCY | 87 | 73 |
| | (32 + 125 ppm) | | |
| 11 | RHAP + PROCY | 77 | 63 |
| | (16 + 62.5 ppm) | | |

TABLE 9

| | Mixture according | Observed | Calculated |
|---|---|---|---|
| Example | to the invention | efficacy | efficacy |
| 1 | Control (untreated) | (100% | 0 |
| | | infection) | |
| 2 | EPIC-G + RESV | 96 | 86 |
| | (62.5 + 62.5 ppm) | | |
| 3 | EPIC-G + RESV | 92 | 78 |
| | (32 + 32 ppm) | | |
| 4 | EPIC-G + RESV | 72 | 54 |
| | (16 + 16 ppm) | | |
| 5 | EPIC-G + RESV | 92 | 84 |
| | (62.5 + 32 ppm) | | |
| 6 | EPIC-G + RESV | 83 | 71 |
| | (32 + 16 ppm) | | |
| 7 | EPIC-G + RESV | 93 | 81 |
| | (32 + 62.5 ppm) | | |
| 8 | EPIC-G + RESV | 84 | 72 |
| | (62.5 + 16 ppm) | | |
| 9 | EPIC-G + RESV | 83 | 69 |
| | (16 + 62.5 ppm) | | |

### LIST OF ABBREVIATIONS

EPIC-G Epigallocatechin gallate
GAL-C Gallocatechin
PROCY Procyanidine
RESV Resveratrol (trans-3,5 4′-trihydroxystilbene)
RHAP Rhaponticin
TH-STIB-GI Trihydroxystilbenglucoside: 3,4′,5-trihydroxystilbene-3-O-beta-D-glucopyranoside

1. An active ingredient composition for fighting plant diseases, comprising:
at least two different active ingredients selected from the group of stilbenes and/or their derivatives, and from the group of galloylated flavan-3-ols and/or their derivatives and/or from the group of the porathocyanidins and/or their derivatives.

2. An active ingredient composition for fighting plant diseases, comprising:
at least two different active ingredients selected from the group of the galloylated flavan-3-ols and/or their derivatives and/or from the group of proanthocyanidins and/or their derivatives.

3. The active ingredient composition according to claim 1, wherein the at least two different active ingredients are intermixed in a ratio from 1:1 to 1:8.

4. The active ingredient composition according to claim 1, wherein the at least two different galloylated flavan-3-ols are epigallocatechin gallate and gallocatechin.

5. The active Active ingredient formulation comprised of a ready-to-use solution, an emulsifiable concentrate, an emulsion, a suspension, a spray powder, a soluble powder and/or a granulate of an active ingredient composition according to claim 1, and additional additives in form of adjuvants.

6. The active ingredient formulation according to claim 5, wherein the concentration of active ingredients in the active ingredient formulation is between 4 and 2000 ppm.

7. A method of using an active ingredient composition according to claim 1, wherein the phytopathogenic fungi to be attacked include one or more phytopathogenic fungi.

8. A method of fighting fungal plant diseases, comprising the steps of selecting at least two different active ingredients from the group consisting of stilbenes and/or derivatives thereof, and, from the group of galloylated flavan-3-ols and/or derivatives thereof and/or from the group of porathocyanidine and/or its derivatives, applying on a plant to be treated simultaneously, jointly, separately, or sequentially, as such or in their formulations.

9. A method of fighting fungal plant diseases, comprising the steps of selecting at least two different active ingredients selected from the group of galloylated flavan-3-ols and/or derivatives thereof and/or from the group of proanthocyanidins and/or derivatives thereof,
applying on a plant to be treated simultaneously, jointly or separately, or in succession as such or in their formulations.

10. The method of claim 8, wherein the active ingredients or their formulations are also applied as a mixture, simultaneously, before or afterwards, with additional fungicides, bactericides, acaricides, nematicides, insecticides and/or further additional ingredients including herbicides, and/or with fertilizers and/or growth regulators.

11. The method according to claim 8, wherein the active ingredients are applied at a concentration in between 4 and 2000 ppm.

12. The active ingredient composition according to claim 3, wherein the at least two different active ingredients are intermixed in a ratio from 1:1 to 1:4,

13. The active ingredient composition according to claim 3, wherein the at least two different active ingredients are intermixed in a ratio from 1:1 to 1:2.

14. The active ingredient formulation according to claim 5, wherein the concentration of active ingredients in the active ingredient formulation is between 8 and 500 ppm.

15. The method according to claim 8, wherein the active ingredients are applied at a concentration in between 8 and 500 ppm.

16. The active ingredient composition according to claim 2, wherein the at least two different active ingredients are intermixed in a ratio from 1:1 to 1:8.

17. The active ingredient composition according to claim 1, wherein the at least two different galloylated flavan-3-ols are epigallocatechin gallate and gallocatechin.

18. The active ingredient composition according to claim 2, wherein the at least two different active ingredients are intermixed in a ratio from 1:1 to 1:4.

19. The active ingredient composition according to claim 2, wherein the at least two different active ingredients are intermixed in a ratio from 1:1 to 1:2.
